(19) United States
(12) Patent Application Publication
(10) Pub. No.: US 2020/0026107 A1
(43) Pub. Date: Jan. 23, 2020

(54) DISPLAY PANEL AND DISPLAY DEVICE

(71) Applicants: HKC Corporation Limited, Baoan Dist. Shenzhen (CN); Chongqing HKC Optoelectronics Technology Co. Ltd., Chongqing (CN)

(72) Inventor: CHUNG-KUANG CHIEN, Chongqing (CN)

(21) Appl. No.: 15/744,854

(22) PCT Filed: May 10, 2017
(86) PCT No.: PCT/CN2017/083792

§ 371 Date: Jan. 15, 2018

(30) Foreign Application Priority Data
Apr. 11, 2017 (CN) 201710236036.3

(51) Int. Cl. G02F 1/1339; C09J 133/18; C09J 133/04; C09J 183/14

(52) U.S. Cl. CPC G02F 1/1339; C09J 183/14; C09J 133/04; C09J 133/18

(57) ABSTRACT

A display panel and a display device are described herein. The display panel includes a first substrate, a second substrate disposed opposite to the first substrate, and a sealant frame formed between the first substrate and the second substrate. The sealant frame is made of an adhesive substance hardened through a self volatile hardening process or a thermosetting process.

### CROSS-REFERENCE TO RELATED APPLICATION

This application claims the benefit of China Patent Application No. 201710236036.3, filed on Apr. 11, 2017, in the State Intellectual Property Office of the People's Republic of China, the disclosure of which is incorporated herein in its entirety by reference.

### FIELD OF THE INVENTION

The present application relates to display technology, more specifically, to a display panel and a display device.

### BACKGROUND OF THE INVENTION

Because of thinner physical body, higher energy efficiency, and lower radiation emission, flat panel display becomes a mainstream product being broadly used in various kinds of applications. Most of flat panel displays are backlit type including a display device and a backlight module. The display device includes liquid crystal molecules disposed between two parallel substrates. When a driving voltage is applied on the substrates, the liquid crystal molecules are oriented allowing for the control of light from the backlight module to form images.

Among LCDs, the Thin Film Transistor-Liquid Crystal Display or TFT-LCD is becoming prominent in display industry because of its low-power consumption, high image quality, and good production yield. Similarly, a TFT-LCD also includes a display device and a backlight module, wherein display device contains a color filter substrate or a CF substrate and a thin film transistor substrate (TFT Substrate). There are additionally a transparent electrode and a layer of liquid crystal molecules (LC molecules) located between these substrates. When an electric field is applied, the liquid crystal molecules are oriented which changes the polarization of the incident light. With the help of the polarizing filter to allow the light to pass through or to block it, the liquid crystal display can then create images.

On the other hand, the OLED display produces color light in quite a different way. The OLED display make use of organic light-emitting diodes (OLED) or UIV OLED to reproduce light. OLED display possesses advantages of wide viewing angle, near infinite contrast ratio, lower power consumption, and short response time, and its pixels emit light by themselves.

All these display panel however need liquid adhesive substances to secure the substrates together. To apply and to harden these substances with convention liquid adhesive substances, high cost equipment and long production time become problems.

### SUMMARY OF THE INVENTION

In order to solve the aforementioned problems, the purpose of the present application is to offer a display panel, which requires lower cost of materials and has its productivity improved.

For this purpose, the present application provides the following technical solutions.

A display panel, comprising: a first substrate; a second substrate, which is disposed opposite to the first substrate; a sealant frame, which is formed between the first substrate and the second substrate; wherein the sealant frame is made of an adhesive substance hardened through a self volatile hardening process or a thermosetting process.

Furthermore, an additional alignment layer may be disposed on the first substrate. The sealant frame is spread on both the alignment layer and on the first substrate. The first substrate may generally be made of glass material, which does not absorb moisture or water vapor so that adhesion is stable. The alignment layer may be made of an organic material, which is similar to the material of sealant frame so that the adhesive strength is good. When the sealant frame is spread on both the first substrate and the alignment layer, the adhesion is both stable and strong.

Alternatively, an alignment layer may be disposed on the first substrate. The sealant frame may be disposed only on the first substrate. The alignment layer may be disposed at an inner side of the sealant frame. The first substrate may generally be made of glass material, which does not absorb moisture or water vapor so that adhesion is stable, and the sealant frame is not easily torn for the substrate after a period of use. This improves the stability of the product.

Furthermore, an additional first trench may be disposed on the first substrate at a location corresponding to the sealant frame. Because of the first trench, when applying the adhesive substance, it tends to remain nearby the first trench and is less likely to flow away, and when the adhesive substance is suppressed during hardening and binding, it is less likely to spread into the display area of the display panel, which might contaminate liquid crystal molecules. Therefore, this helps to improve the display quality.

Alternatively, an alignment layer may be disposed on the first substrate, and the sealant frame may be disposed only on the alignment layer. The alignment layer may be made of an organic material, which is similar to the material of the adhesive substance, so that the adhesive strength of the adhesive substance is enhanced, which improves the binding force therebetween.

Additionally, a second trench may be disposed on the first substrate at a location corresponding to the sealant frame. A third trench may be disposed on the alignment layer at a location corresponding to the second trench. Because of the third trench, when applying the adhesive substance, it is less likely to flow away and tends to remain nearby the third trench, and when the adhesive substance is suppressed during hardening and binding, it is less likely to spread into the display area of the display panel, which might contaminate liquid crystal molecules. Therefore, the display quality is improved.

Additionally, the adhesive substance may include acrylate compound. The structure of acrylate compound is characterized as being high-polar and completely saturated, so that it has good mineral oil resistance, oxidation resistance, and high temperature endurance. The oil resistance is only second to fluororubber and is similar to nitrile butadiene rubber containing medium or high content of acrylonitrile. The temperature endurance may be between all-purpose rubber and silicone rubber or fluororubber, and the operating temperature is 30° C. to 60° C. higher than nitrile butadiene rubber. The highest operating temperature is 180° C. When exposed in intermittent or short-term manner, it may withstand 200° C. Under 150° C. aging process for years, the characteristics of it are not obviously changed. The adhesive substance is stable in the extreme-pressure type lubricant including extreme-pressure additive containing sulfur, chlorine, phosphorus, etc. The operating temperature in the lubricant can be as high as 150° C. and even higher when exposed in an intermittent or short-term manner. As for nitrile butadiene rubber with double bonds, it becomes hardened and brittle at a temperature higher than 110° C. when immersed in the oil including an extreme-pressure additive. Acrylate rubber also has good ozone resistance, air tightness, flex crack growth resistance, UV discoloration resistance, etc. The adhesive substance including acrylate in the present application can be hardened through a thermosetting process. Because the thermosetting equipment is relatively simple and cheap and the thermosetting time requirement is relatively short, the productivity is therefore improved.

Furthermore, the adhesive substance may comprise a compound formed by aluminosiloxane, dual-end silanol type silicone oil, and silicone alkoxy oligomer. A polycondensation reaction is caused between aluminosiloxane, dual-end silanol type silicone oil, and silicone alkoxy oligomer. The resulting compound has properties of transparency, a large number of crosslinking, high crosslinking density, and large bond energy, and offers not only excellent light transmittance and heat resistance but also excellent tensile modulus. It is considered that the resulting compound has no absorption in the ultraviolet region in which an organic substance is degraded, and is less likely to undergo photodegradation, so that the thermosetting composition shows excellent brightness-maintaining percentage upon encapsulation. Therefore, the adhesive substance is a good thermosetting adhesive material. Because the thermosetting equipment is relatively simple and cheap and the thermosetting time requirement is relatively short, the productivity is improved.

Alternatively, the adhesive substance comprises ethyl α-cyanoacrylate compound. Ethyl α-cyanoacrylate is colorless, of low viscosity, of nonflammable liquid, of pure form without solvent, of a little bit stimulating smell, and volatile, and its vapor can minorly cause tears. When ethyl α-cyanoacrylate is exposed to water vapor, it rapidly adhesively hardens, and the resulting substance shows no toxicity. Because only a small amount of water vapor is required to catalyze the polymerization and solidification of the ethyl α-cyanoacrylate, it can harden rather fast. The adhesive substance comprising ethyl α-cyanoacrylate in the present application can be hardened through a self volatile hardening process without the need of any extra equipment. The cost is therefore lowered. The hardening time requirement is also relatively short, and the productivity is therefore improved.

According to the other aspect of the present application, a display device is further provided, comprising the aforementioned display panel.

In the present application, self volatile hardening or thermosetting adhesive substance is used as the material of the sealant frame, the required temperature control equipment is much cheaper and the hardening time can be controlled. Comparing with those sophisticated UV curing and coating equipment, the present application provides advantages in both cost and productivity. Besides, the self volatile adhesive substance requires no hardening equipment at all. The manufacturing cost is further lowered.

### BRIEF DESCRIPTION OF THE DRAWINGS

FIG. 1 is a schematic diagram of a structure of a display panel in an embodiment of the present application.

FIG. 2 is a schematic diagram of another structure of a display panel in an embodiment of the present application.

FIG. 3 is a schematic diagram of another structure of a display panel in an embodiment of the present application.

FIG. 4 is a schematic diagram of another structure of a display panel in an embodiment of the present application.

FIG. 5 is a schematic diagram of another structure of a display panel in an embodiment of the present application.

FIG. 6 is a schematic diagram of another structure of a display panel in an embodiment of the present application.

FIG. 7 is a schematic diagram of a manufacturing method of a display panel in an embodiment of the present application.

### DESCRIPTION OF THE PREFERRED EMBODIMENTS

The specific structures and functions provided herein are only representative, and the purpose thereof is to illustrate the embodiments of the present application. The present application however may be embodied in many alternative forms and should not be construed as being limited to the embodiments set forth herein.

In the description of the present application, it is noted that the directional or positioning terms such as “center”, “horizontal”, “upper”, “lower”, “left”, “right”, “vertical”, “level”, “top”, “bottom”, “inside”, “outside”, etc. are based on the positions or positional relationship shown in the drawings. The purpose is to facilitate the description of the present application and to simplify description, but not to indicate or to imply that the devices or elements are limited to specific directions or positions, or constructed or operated in specific orientations. These terms therefore can not be construed as limiting the present application. In addition, the terms “first”, “second”, etc. are for illustrative purposes only and are not to be construed as indicating or imposing a relative importance or implying or indicating the number of technical features. For the technical features described by “first”, “second”, etc., the present application should be construed as expressly or implicitly including one or more of such features. In the present application, “many” or “a plurality of” is to indicate two or more unless otherwise defined. In addition, the terms “include” and any variants of them are intended to mean non-exclusive inclusion.

In the description of the present application, it should be understood that, unless specified or limited otherwise, the terms “mounted”, “connected”, “coupled”, and variations thereof are broadly to express such as fixedly coupled, detachably coupled, or formed as a single element and encompass such as mechanical or electrical mountings, connections and couplings, also can be inner mountings, connections and couplings of two components, and further can be direct and indirect mountings, connections, and couplings, which can be understood by those skilled in the art according to the content of the embodiments of the present application.

The terms used herein are to illustrate but not to limit the embodiments of the present application. Unless specifically specified in the context, the singular forms “a”, “an”, “the”, etc. are intended to include the plural forms. It should also be understood that the terms “comprises” and/or “comprising” used in this specification, specify the presence of stated features, integers, steps, operations, elements, and/or components, but do not preclude the presence or addition of one or more other features, integers, steps, operations, elements, components, and/or groups thereof.

Accompanying with the corresponding figures, the following will illustrate the preferred embodiments of the present application.

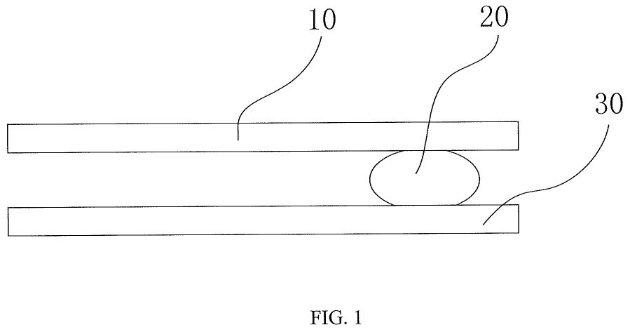

The following refers to FIG. 1, which shows an embodiment of a display panel. The display panel comprises: a first substrate 10; a second substrate 20 disposed opposite to the first substrate 10; a sealant frame 30 formed between the first substrate 10 and the second substrate 20; wherein the sealant frame 30 is made of a self volatile hardening or a thermosetting adhesive substance.

Using thermosetting adhesive substance as the material of the sealant frame, the required temperature control equipment is much cheaper and the hardening time can be controlled. Comparing with those sophisticated UV curing and coating equipment, the present application provides advantages in both cost and productivity. Besides, the self volatile adhesive substance requires no hardening equipment at all. The manufacturing cost is further lowered.

Optionally, acrylate compound is used for the thermosetting adhesive substance. The structure of acrylate compound is characterized as being high-polar and completely saturated, so that it has good mineral oil resistance, oxidation resistance, and high temperature endurance. The oil resistance is only second to fluororubber and is similar to nitrile butadiene rubber containing medium or high content of acrylonitrile. The temperature endurance is between all-purpose rubber and silicone rubber or fluororubber, and the operating temperature is 30° C. to 60° C. higher than nitrile butadiene rubber. The highest operating temperature is 180° C. When exposed in intermittent or short-term manner, it may withstand 200° C. Under 150° C. aging process for years, the characteristics of it are not obviously changed. The adhesive substance is stable in the extreme-pressure type lubricant including extreme-pressure additive containing sulfur, chlorine, phosphorus, etc. The operating temperature in the lubricant can be as high as 150° C. and even higher when exposed in an intermittent or short-term manner. As for nitrile butadiene rubber with double bonds, it becomes hardened and brittle at a temperature higher than 110° C. when immersed in the oil including an extreme-pressure additive. Acrylate rubber also has good ozone resistance, air tightness, flex crack growth resistance, UV discoloration resistance, etc. The adhesive substance including acrylate in the present application can be hardened through a thermosetting process. Because the thermosetting equipment is relatively simple and cheap and the thermosetting time requirement is relatively short, the productivity is therefore improved.

Optionally, the thermosetting adhesive substance may comprise a compound formed by aluminosiloxane, dual-end silanol type silicone oil, and silicone alkoxy oligomer. A polycondensation reaction is caused between aluminosiloxane, dual-end silanol type silicone oil, and silicone alkoxy oligomer. The resulting compound has properties of transparency, a large number of crosslinking, high crosslinking density, and large bond energy, and offers not only excellent light transmittance and heat resistance but also excellent tensile modulus. It is considered that the resulting compound has no absorption in the ultraviolet region in which an organic substance is degraded, and is less likely to undergo photodegradation, so that the thermosetting composition shows excellent brightness-maintaining percentage upon encapsulation. Therefore, the adhesive substance is a good thermosetting adhesive material. Because the thermosetting equipment is relatively simple and cheap and the thermosetting time requirement is relatively short, the productivity is improved.

Optionally, the self volatile hardening adhesive substance may comprise ethyl α-cyanoacrylate compound. Ethyl α-cyanoacrylate is colorless, of low viscosity, of nonflammable liquid, of pure form without solvent, of a little bit stimulating smell, and volatile, and its vapor can minorly cause tears. When ethyl α-cyanoacrylate is exposed to water vapor, it rapidly adhesively hardens, and the resulting substance shows no toxicity. Because only a small amount of water vapor is required to catalyze the polymerization and solidification of the ethyl α-cyanoacrylate, it can harden rather fast. The adhesive substance comprising ethyl α-cyanoacrylate in the present application can be hardened through a self volatile hardening process without the need of any extra equipment. The cost is therefore lowered. The hardening time requirement is also relatively short, and the productivity is therefore improved.

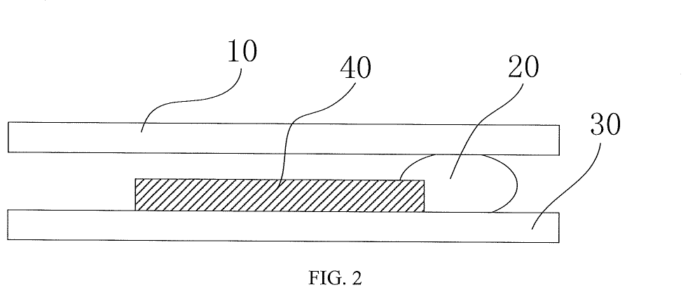

The following refers to FIG. 2, which shows an embodiment of a display panel. The display panel comprises: a first substrate 10; a second substrate 20 disposed opposite to the first substrate 10; a sealant frame 30 formed between the first substrate 10 and the second substrate 20; wherein the sealant frame 30 is made of a self volatile hardening or a thermosetting adhesive substance.

An alignment layer 40 is disposed on the first substrate 10, and the sealant frame 30 is spread on both the alignment layer 40 and the first substrate 10. The first substrate 10 is made of glass material, which does not absorb moisture or water vapor so that adhesion is stable; the alignment layer 40 is made of an organic material, which is similar to the material of sealant frame so that the adhesive strength is good. Therefore, when the sealant frame is spread on both the first substrate 10 and the alignment layer 40, the adhesive stability and strength can both be acquired.

Optionally, acrylate compound is used for the thermosetting adhesive substance. The structure of acrylate compound is characterized as being high-polar and completely saturated, so that it has good mineral oil resistance, oxidation resistance, and high temperature endurance. The oil resistance is only second to fluororubber and is similar to nitrile butadiene rubber containing medium or high content of acrylonitrile. The temperature endurance is between all-purpose rubber and silicone rubber or fluororubber, and the operating temperature is 30° C. to 60° C. higher than nitrile butadiene rubber. The highest operating temperature is 180° C. When exposed in intermittent or short-term manner, it may withstand 200° C. Under 150° C. aging process for years, the characteristics of it are not obviously changed. The adhesive substance is stable in the extreme-pressure type lubricant including extreme-pressure additive containing sulfur, chlorine, phosphorus, etc. The operating temperature in the lubricant can be as high as 150° C. and even higher when exposed in an intermittent or short-term manner. As for nitrile butadiene rubber with double bonds, it becomes hardened and brittle at a temperature higher than 110° C. when immersed in the oil including an extreme-pressure additive. Acrylate rubber also has good ozone resistance, air tightness, flex crack growth resistance, UV discoloration resistance, etc. The adhesive substance including acrylate in the present application can be hardened through a thermosetting process. Because the thermosetting equipment is relatively simple and cheap and the thermosetting time requirement is relatively short, the productivity is therefore improved.

Optionally, the thermosetting adhesive substance may comprise a compound formed by aluminosiloxane, dual-end silanol type silicone oil, and silicone alkoxy oligomer. A polycondensation reaction is caused between aluminosiloxane, dual-end silanol type silicone oil, and silicone alkoxy oligomer. The resulting compound has properties of transparency, a large number of crosslinking, high crosslinking density, and large bond energy, and offers not only excellent light transmittance and heat resistance but also excellent tensile modulus. It is considered that the resulting compound has no absorption in the ultraviolet region in which an organic substance is degraded, and is less likely to undergo photodegradation, so that the thermosetting composition shows excellent brightness-maintaining percentage upon encapsulation. Therefore, the adhesive substance is a good thermosetting adhesive material. Because the thermosetting equipment is relatively simple and cheap and the thermosetting time requirement is relatively short, the productivity is improved.

Optionally, the self volatile hardening adhesive substance may comprise ethyl α-cyanoacrylate compound. Ethyl α-cyanoacrylate is colorless, of low viscosity, of nonflammable liquid, of pure form without solvent, of a little bit stimulating smell, and volatile, and its vapor can minorly cause tears. When ethyl α-cyanoacrylate is exposed to water vapor, it rapidly adhesively hardens, and the resulting substance shows no toxicity. Because only a small amount of water vapor is required to catalyze the polymerization and solidification of the ethyl α-cyanoacrylate, it can harden rather fast. The adhesive substance comprising ethyl α-cyanoacrylate in the present application can be hardened through a self volatile hardening process without the need of any extra equipment. The cost is therefore lowered. The hardening time requirement is also relatively short, and the productivity is therefore improved.

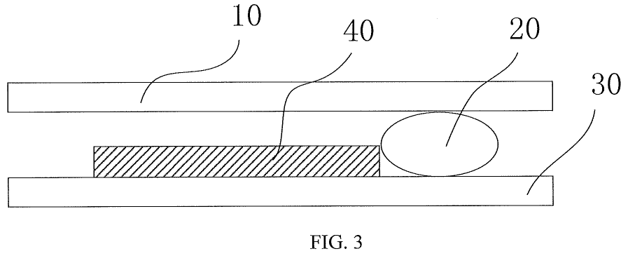

The following refers to FIG. 3, which shows an embodiment of a display panel. The display panel comprises: a first substrate 10; a second substrate 20 disposed opposite to the first substrate 10; a sealant frame 30 formed between the first substrate 10 and the second substrate 20; wherein the sealant frame 30 is made of a self volatile hardening or a thermosetting adhesive substance.

An alignment layer 40 is disposed on the first substrate 10; the sealant frame 30 is disposed only on the first substrate 10; the alignment layer 40 is disposed at an inner side of the sealant frame 30. The first substrate 10 is made of glass material, which does not absorb moisture or water vapor so that adhesion is stable, and the sealant frame is not easily torn from the substrate after a period of use. This improves the stability of the product.

Optionally, acrylate compound is used for the thermosetting adhesive substance. The structure of acrylate compound is characterized as being high-polar and completely saturated, so that it has good mineral oil resistance, oxidation resistance, and high temperature endurance. The oil resistance is only second to fluororubber and is similar to nitrile butadiene rubber containing medium or high content of acrylonitrile. The temperature endurance is between all-purpose rubber and silicone rubber or fluororubber, and the operating temperature is 30° C. to 60° C. higher than nitrile butadiene rubber. The highest operating temperature is 180° C. When exposed in intermittent or short-term manner, it may withstand 200° C. Under 150° C. aging process for years, the characteristics of it are not obviously changed. The adhesive substance is stable in the extreme-pressure type lubricant including extreme-pressure additive containing sulfur, chlorine, phosphorus, etc. The operating temperature in the lubricant can be as high as 150° C. and even higher when exposed in an intermittent or short-term manner. As for nitrile butadiene rubber with double bonds, it becomes hardened and brittle at a temperature higher than 110° C. when immersed in the oil including an extreme-pressure additive. Acrylate rubber also has good ozone resistance, air tightness, flex crack growth resistance, UV discoloration resistance, etc. The adhesive substance including acrylate in the present application can be hardened through a thermosetting process. Because the thermosetting equipment is relatively simple and cheap and the thermosetting time requirement is relatively short, the productivity is therefore improved.

Optionally, the thermosetting adhesive substance may comprise a compound formed by aluminosiloxane, dual-end silanol type silicone oil, and silicone alkoxy oligomer. A polycondensation reaction is caused between aluminosiloxane, dual-end silanol type silicone oil, and silicone alkoxy oligomer. The resulting compound has properties of transparency, a large number of crosslinking, high crosslinking density, and large bond energy, and offers not only excellent light transmittance and heat resistance but also excellent tensile modulus. It is considered that the resulting compound has no absorption in the ultraviolet region in which an organic substance is degraded, and is less likely to undergo photodegradation, so that the thermosetting composition shows excellent brightness-maintaining percentage upon encapsulation. Therefore, the adhesive substance is a good thermosetting adhesive material. Because the thermosetting equipment is relatively simple and cheap and the thermosetting time requirement is relatively short, the productivity is improved.

Optionally, the self volatile hardening adhesive substance may comprise ethyl α-cyanoacrylate compound. Ethyl α-cyanoacrylate is colorless, of low viscosity, of nonflammable liquid, of pure form without solvent, of a little bit stimulating smell, and volatile, and its vapor can minorly cause tears. When ethyl α-cyanoacrylate is exposed to water vapor, it rapidly adhesively hardens, and the resulting substance shows no toxicity. Because only a small amount of water vapor is required to catalyze the polymerization and solidification of the ethyl α-cyanoacrylate, it can harden rather fast. The adhesive substance comprising ethyl α-cyanoacrylate in the present application can be hardened through a self volatile hardening process without the need of any extra equipment. The cost is therefore lowered. The hardening time requirement is also relatively short, and the productivity is therefore improved.

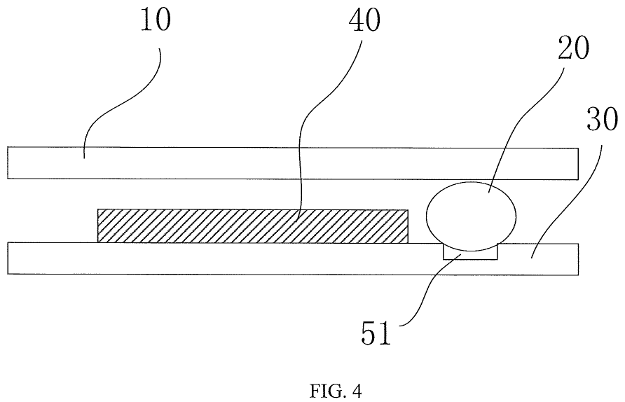

The following refers to FIG. 4, which shows an embodiment of a display panel. The display panel comprises: a first substrate 10; a second substrate 20 disposed opposite to the first substrate 10; a sealant frame 30 formed between the first substrate 10 and the second substrate 20; wherein the sealant frame 30 is made of a self volatile hardening or a thermosetting adhesive substance.

An alignment layer 40 is disposed on the first substrate 10. the sealant frame 30 is disposed only on the first substrate 10. the alignment layer 40 is disposed at an inner side of the sealant frame 30. An additional first trench 51 is disposed on the first substrate at a location corresponding to the sealant frame 30. The first substrate 10 is made of glass material, which does not absorb moisture or water vapor so that adhesion is stable, and the sealant frame is not easily torn from the substrate after a period of use. This improves the stability of the product. Because of the first trench 51, when applying the adhesive substance, it tends to remain nearby the first trench and is less likely to flow away, and when the adhesive substance is suppressed during hardening and binding, it is less likely to spread into the display area of the display panel, which might contaminate liquid crystal molecules. Therefore, this helps to improve the display quality.

Optionally, acrylate compound is used for the thermosetting adhesive substance. The structure of acrylate compound is characterized as being high-polar and completely saturated, so that it has good mineral oil resistance, oxidation resistance, and high temperature endurance. The oil resistance is only second to fluororubber and is similar to nitrile butadiene rubber containing medium or high content of acrylonitrile. The temperature endurance is between all-purpose rubber and silicone rubber or fluororubber, and the operating temperature is 30° C. to 60° C. higher than nitrile butadiene rubber. The highest operating temperature is 180° C. When exposed in intermittent or short-term manner, it may withstand 200° C. Under 150° C. aging process for years, the characteristics of it are not obviously changed. The adhesive substance is stable in the extreme-pressure type lubricant including extreme-pressure additive containing sulfur, chlorine, phosphorus, etc. The operating temperature in the lubricant can be as high as 150° C. and even higher when exposed in an intermittent or short-term manner. As for nitrile butadiene rubber with double bonds, it becomes hardened and brittle at a temperature higher than 110° C. when immersed in the oil including an extreme-pressure additive. Acrylate rubber also has good ozone resistance, air tightness, flex crack growth resistance, UV discoloration resistance, etc. The adhesive substance including acrylate in the present application can be hardened through a thermosetting process. Because the thermosetting equipment is relatively simple and cheap and the thermosetting time requirement is relatively short, the productivity is therefore improved.

Optionally, the thermosetting adhesive substance may comprise a compound formed by aluminosiloxane, dual-end silanol type silicone oil, and silicone alkoxy oligomer. A polycondensation reaction is caused between aluminosiloxane, dual-end silanol type silicone oil, and silicone alkoxy oligomer. The resulting compound has properties of transparency, a large number of crosslinking, high crosslinking density, and large bond energy, and offers not only excellent light transmittance and heat resistance but also excellent tensile modulus. It is considered that the resulting compound has no absorption in the ultraviolet region in which an organic substance is degraded, and is less likely to undergo photodegradation, so that the thermosetting composition shows excellent brightness-maintaining percentage upon encapsulation. Therefore, the adhesive substance is a good thermosetting adhesive material. Because the thermosetting equipment is relatively simple and cheap and the thermosetting time requirement is relatively short, the productivity is improved.

Optionally, the self volatile hardening adhesive substance may comprise ethyl α-cyanoacrylate compound. Ethyl α-cyanoacrylate is colorless, of low viscosity, of nonflammable liquid, of pure form without solvent, of a little bit stimulating smell, and volatile, and its vapor can minorly cause tears. When ethyl α-cyanoacrylate is exposed to water vapor, it rapidly adhesively hardens, and the resulting substance shows no toxicity. Because only a small amount of water vapor is required to catalyze the polymerization and solidification of the ethyl α-cyanoacrylate, it can harden rather fast. The adhesive substance comprising ethyl α-cyanoacrylate in the present application can be hardened through a self volatile hardening process without the need of any extra equipment. The cost is therefore lowered. The hardening time requirement is also relatively short, and the productivity is therefore improved.

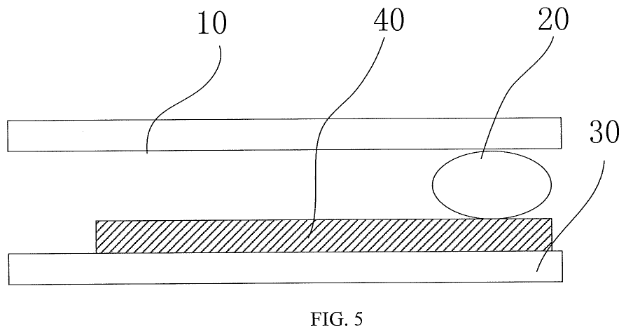

The following refers to FIG. 5, which shows an embodiment of a display panel. The display panel comprises: a first substrate 10; a second substrate 20 disposed opposite to the first substrate 10; a sealant frame 30 formed between the first substrate 10 and the second substrate 20; wherein the sealant frame 30 is made of a self volatile hardening or a thermosetting adhesive substance.

An alignment layer 40 is disposed on the first substrate 10, and the sealant frame 30 is applied only on the alignment layer 40. The alignment layer 40 is made of an organic material, which is similar to the material of adhesive substance, so that the adhesive strength of the adhesive substance is enhanced to improve the binding force.

Optionally, acrylate compound is used for the thermosetting adhesive substance. The structure of acrylate compound is characterized as being high-polar and completely saturated, so that it has good mineral oil resistance, oxidation resistance, and high temperature endurance. The oil resistance is only second to fluororubber and is similar to nitrile butadiene rubber containing medium or high content of acrylonitrile. The temperature endurance is between all-purpose rubber and silicone rubber or fluororubber, and the operating temperature is 30° C. to 60° C. higher than nitrile butadiene rubber. The highest operating temperature is 180° C. When exposed in intermittent or short-term manner, it may withstand 200° C. Under 150° C. aging process for years, the characteristics of it are not obviously changed. The adhesive substance is stable in the extreme-pressure type lubricant including extreme-pressure additive containing sulfur, chlorine, phosphorus, etc. The operating temperature in the lubricant can be as high as 150° C. and even higher when exposed in an intermittent or short-term manner. As for nitrile butadiene rubber with double bonds, it becomes hardened and brittle at a temperature higher than 110° C. when immersed in the oil including an extreme-pressure additive. Acrylate rubber also has good ozone resistance, air tightness, flex crack growth resistance, UV discoloration resistance, etc. The adhesive substance including acrylate in the present application can be hardened through a thermosetting process. Because the thermosetting equipment is relatively simple and cheap and the thermosetting time requirement is relatively short, the productivity is therefore improved.

Optionally, the thermosetting adhesive substance may comprise a compound formed by aluminosiloxane, dual-end silanol type silicone oil, and silicone alkoxy oligomer. A polycondensation reaction is caused between aluminosiloxane, dual-end silanol type silicone oil, and silicone alkoxy oligomer. The resulting compound has properties of transparency, a large number of crosslinking, high crosslinking density, and large bond energy, and offers not only excellent light transmittance and heat resistance but also excellent tensile modulus. It is considered that the resulting compound has no absorption in the ultraviolet region in which an organic substance is degraded, and is less likely to undergo photodegradation, so that the thermosetting composition shows excellent brightness-maintaining percentage upon encapsulation. Therefore, the adhesive substance is a good thermosetting adhesive material. Because the thermosetting equipment is relatively simple and cheap and the thermosetting time requirement is relatively short, the productivity is improved.

Optionally, the self volatile hardening adhesive substance may comprise ethyl α-cyanoacrylate compound. Ethyl α-cyanoacrylate is colorless, of low viscosity, of nonflammable liquid, of pure form without solvent, of a little bit stimulating smell, and volatile, and its vapor can minorly cause tears. When ethyl α-cyanoacrylate is exposed to water vapor, it rapidly adhesively hardens, and the resulting substance shows no toxicity. Because only a small amount of water vapor is required to catalyze the polymerization and solidification of the ethyl α-cyanoacrylate, it can harden rather fast. The adhesive substance comprising ethyl α-cyanoacrylate in the present application can be hardened through a self volatile hardening process without the need of any extra equipment. The cost is therefore lowered. The hardening time requirement is also relatively short, and the productivity is therefore improved.

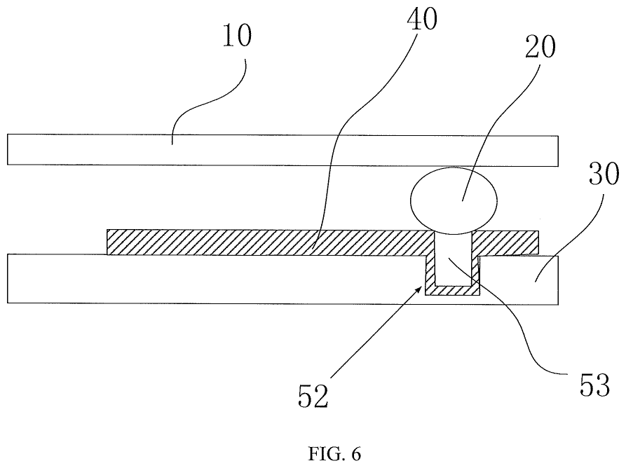

The following refers to FIG. 6, which shows an embodiment of a display panel. The display panel comprises: a first substrate 10; a second substrate 20 disposed opposite to the first substrate 10; a sealant frame 30 formed between the first substrate 10 and the second substrate 20; wherein the sealant frame 30 is made of a self volatile hardening or a thermosetting adhesive substance.

An alignment layer 40 is disposed on the first substrate 10, and the sealant frame 30 is applied only on the alignment layer 40. A second trench 52 is disposed on the first substrate 10 at a location corresponding to the sealant frame 30; a third trench 53 is disposed on the alignment layer 40 at a location corresponding to the second trench 52. The alignment layer 40 is made of an organic material, which is similar to the material of adhesive substance, so that the adhesive strength of the adhesive substance is enhanced to improve the binding force. Because of the third trench 53, when applying the adhesive substance, it is less likely to flow away and tends to remain nearby the third trench 53, and when the adhesive substance is suppressed during hardening and binding, it is less likely to spread into the display area of the display panel, which might contaminate liquid crystal molecules. Therefore, the display quality is improved.

Optionally, acrylate compound is used for the thermosetting adhesive substance. The structure of acrylate compound is characterized as being high-polar and completely saturated, so that it has good mineral oil resistance, oxidation resistance, and high temperature endurance. The oil resistance is only second to fluororubber and is similar to nitrile butadiene rubber containing medium or high content of acrylonitrile. The temperature endurance is between all-purpose rubber and silicone rubber or fluororubber, and the operating temperature is 30° C. to 60° C. higher than nitrile butadiene rubber. The highest operating temperature is 180° C. When exposed in intermittent or short-term manner, it may withstand 200° C. Under 150° C. aging process for years, the characteristics of it are not obviously changed. The adhesive substance is stable in the extreme-pressure type lubricant including extreme-pressure additive containing sulfur, chlorine, phosphorus, etc. The operating temperature in the lubricant can be as high as 150° C. and even higher when exposed in an intermittent or short-term manner. As for nitrile butadiene rubber with double bonds, it becomes hardened and brittle at a temperature higher than 110° C. when immersed in the oil including an extreme-pressure additive. Acrylate rubber also has good ozone resistance, air tightness, flex crack growth resistance, UV discoloration resistance, etc. The adhesive substance including acrylate in the present application can be hardened through a thermosetting process. Because the thermosetting equipment is relatively simple and cheap and the thermosetting time requirement is relatively short, the productivity is therefore improved.

Optionally, the thermosetting adhesive substance may comprise a compound formed by aluminosiloxane, dual-end silanol type silicone oil, and silicone alkoxy oligomer. A polycondensation reaction is caused between aluminosiloxane, dual-end silanol type silicone oil, and silicone alkoxy oligomer. The resulting compound has properties of transparency, a large number of crosslinking, high crosslinking density, and large bond energy, and offers not only excellent light transmittance and heat resistance but also excellent tensile modulus. It is considered that the resulting compound has no absorption in the ultraviolet region in which an organic substance is degraded, and is less likely to undergo photodegradation, so that the thermosetting composition shows excellent brightness-maintaining percentage upon encapsulation. Therefore, the adhesive substance is a good thermosetting adhesive material. Because the thermosetting equipment is relatively simple and cheap and the thermosetting time requirement is relatively short, the productivity is improved.

Optionally, the self volatile hardening adhesive substance may comprise ethyl α-cyanoacrylate compound. Ethyl α-cyanoacrylate is colorless, of low viscosity, of nonflammable liquid, of pure form without solvent, of a little bit stimulating smell, and volatile, and its vapor can minorly cause tears. When ethyl α-cyanoacrylate is exposed to water vapor, it rapidly adhesively hardens, and the resulting substance shows no toxicity. Because only a small amount of water vapor is required to catalyze the polymerization and solidification of the ethyl α-cyanoacrylate, it can harden rather fast. The adhesive substance comprising ethyl α-cyanoacrylate in the present application can be hardened through a self volatile hardening process without the need of any extra equipment. The cost is therefore lowered. The hardening time requirement is also relatively short, and the productivity is therefore improved.

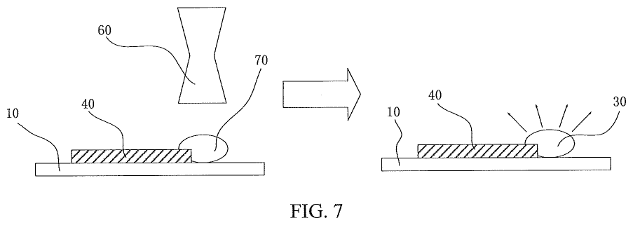

The following refers to FIG. 7, which is a schematic diagram showing a manufacturing method of a display panel in an embodiment of the present application. An adhesive substance 70 is first applied in the peripheral area of the first substrate 10 by an adhesive substance spreader 60. The adhesive substance is then hardened through a self volatile hardening process or a thermosetting process to form a sealant frame 30, wherein an alignment layer is disposed on the first substrate. The relative position of resulting sealant frame, the first substrate, and the alignment layer can refer to the aforementioned embodiments. Comparing to UV curing, the spreading equipment for the thermosetting or self volatile hardening processes is relatively simple and cheap.

The present application also provides a display device, comprising an aforementioned display panel and a backlight module disposed at a light incident surface side of the display panel.

In this embodiment, the display device may comprise a liquid-crystal panel, a plasma panel, or the like. In the case of liquid-crystal panel, the panel comprises an array substrate and a color filter substrate, wherein the array substrate and the color filter substrate (CF) are disposed opposite to one another, and liquid-crystal molecules and a photo spacer (PS) are disposed therebetween. The array substrate comprises a thin film transistor (TFT) and the color filter substrate comprises a color filter layer.

In the aforementioned embodiment, the display device may comprise a curved display panel.

The aforementioned preferred embodiments specifically provide detailed description of the present application, but the present application is not limited to the description. For those skilled in the art, any technical feature that can be obtained by logical analysis, inference, or limited experimentation on the basis of the present application by one skilled in the art should be within the scope of the appended claims.

What is claimed is:

1. A display panel, comprising:
a first substrate;
a second substrate disposed opposite to the first substrate;
a sealant frame formed between the first substrate and the second substrate;
wherein the sealant frame is made of an adhesive substance hardened through a self volatile hardening process or a thermosetting process;
an alignment layer disposed on the first substrate; wherein the sealant frame is spread on both the first substrate and the alignment layer; a first trench disposed on the first substrate at a location corresponding to the sealant frame; wherein the adhesive substance comprises ethyl α-cyanoacrylate compound.

2. A display panel, comprising:
a first substrate;
a second substrate disposed opposite to the first substrate;
a sealant frame formed between the first substrate and the second substrate;
wherein the sealant frame is made of an adhesive substance hardened through a self volatile hardening process or a thermosetting process.

3. The display panel of claim 2, wherein an alignment layer is disposed on the first substrate; and the sealant frame is spread on both the first substrate and the alignment layer.

4. The display panel of claim 2, wherein an alignment layer is disposed on the first substrate; the sealant frame is disposed only on the first substrate; and the alignment layer is disposed at an inner side of the sealant frame.

5. The display panel of claim 4, wherein a first trench is disposed on the first substrate at a location corresponding to the sealant frame.

6. The display panel of claim 2, wherein an alignment layer is disposed on the first substrate; and the sealant frame is disposed only on the alignment layer.

7. The display panel of claim 6, wherein a second trench is disposed on the first substrate at a location corresponding to the sealant frame and a third trench is disposed on the alignment layer at a location corresponding to the second trench.

8. The display panel of claim 2, wherein the adhesive substance comprises acrylate compound.

9. The display panel of claim 2, wherein the adhesive substance comprises a compound formed by aluminosiloxane, dual-end silanol type silicone oil, and silicone alkoxy oligomer.

10. The display panel of claim 2, wherein the adhesive substance comprises ethyl α-cyanoacrylate compound.

11. A display device, comprising a display panel, the display panel comprising:
a first substrate;
a second substrate disposed opposite to the first substrate;
a sealant frame formed between the first substrate and the second substrate;
wherein the sealant frame is made of an adhesive substance hardened through a self volatile hardening process or a thermosetting process.

12. The display device of claim 11, wherein an alignment layer is disposed on the first substrate; and the sealant frame is spread on both the first substrate and the alignment layer.

13. The display device of claim 11, wherein an alignment layer is disposed on the first substrate; the sealant frame is disposed only on the first substrate; and the alignment layer is disposed at an inner side of the sealant frame.

14. The display device of claim 13, further comprising a first trench disposed on the first substrate at a location corresponding to the sealant frame.

15. The display device of claim 11, further comprising an alignment layer disposed on the first substrate; wherein the sealant frame is disposed only on the alignment layer.

16. The display device of claim 15, further comprising a second trench disposed on the first substrate at a location corresponding to the sealant frame and a third trench disposed on the alignment layer at a location corresponding to the second trench.

17. The display device of claim 11, wherein the adhesive substance comprises acrylate compound.

18. The display device of claim 11, wherein the adhesive substance comprises a compound formed by aluminosiloxane, dual-end silanol type silicone oil, and silicone alkoxy oligomer.

19. The display device of claim 11, wherein the adhesive substance comprises ethyl α-cyanoacrylate compound.
